(19) United States
(12) Patent Application Publication
(10) Pub. No.: US 2025/0045566 A1
(43) Pub. Date: Feb. 6, 2025

(54) SYSTEMS AND METHODS FOR CONVOLUTIONAL NEURAL NETWORK AND TRANSFORMER-BASED TIME SERIES MODELING

(71) Applicant: JPMORGAN CHASE BANK, N.A., New York, NY (US)

(72) Inventors: Zhen ZENG, Ypsilanti, MI (US); Rachneet KAUR, Manhattan, NY (US); Suchetha SIDDAGANGAPPA, Brooklyn, NY (US); Tucker Richard BALCH, Suwanee, GA (US); Manuela VELOSO, New York, NY (US); Saba RAHIMI, Laguna Niguel, CA (US)

(21) Appl. No.: 18/365,808

(22) Filed: Aug. 4, 2023

(51) Int. Cl. G06N 3/0455; G06N 3/08

(52) U.S. Cl. CPC G06N 3/0455; G06N 3/08

(57) ABSTRACT

In some aspects, the techniques described herein relate to a method including: receiving, at a forecasting platform, a time series; partitioning the time series into a plurality of partitions; processing the time series with a convolutional neural network machine learning model; generating, by the convolutional neural network machine learning model, a plurality of tokens, wherein the plurality of tokens are based on the time series; processing the plurality of tokens with a transformer machine learning model; generating, by the transformer machine learning model, a transformer vector, wherein the transformer vector is based on relationships among the plurality of tokens determined by the transformer machine learning model; and assigning, by a multilayer perceptron classifier, a classification to the transformer vector.

### BACKGROUND

### 1. Field of the Invention

Aspects generally relate to systems and methods for convolutional neural network and transformer-based time series modeling.

### 2. Description of the Related Art

Time series forecasting is important across various domains for decision-making. Certain time series have proven difficult to predict because it is difficult to model both short-term and long-term temporal dependencies between data points. Convolutional Neural Networks (CNNs) have demonstrated success at capturing local patterns for modeling short-term dependencies. However, CNNs are not good at learning long-term dependencies due to a limited receptive field. Transformers, on the other hand, are capable of learning global context and long-term dependencies.

### SUMMARY

In some aspects, the techniques described herein relate to a method including: receiving, at a forecasting platform, a time series; partitioning the time series into a plurality of partitions; processing the time series with a convolutional neural network machine learning model; generating, by the convolutional neural network machine learning model, a plurality of tokens, wherein the plurality of tokens are based on the time series; processing the plurality of tokens with a transformer machine learning model; generating, by the transformer machine learning model, a transformer vector, wherein the transformer vector is based on relationships among the plurality of tokens determined by the transformer machine learning model; and assigning, by a multilayer perceptron classifier, a classification to the transformer vector.

In some aspects, the techniques described herein relate to a method, wherein each of the plurality of tokens corresponds to a partition of the plurality of partitions.

In some aspects, the techniques described herein relate to a method, wherein each of the plurality of tokens includes a multidimensional vector space.

In some aspects, the techniques described herein relate to a method, wherein a number of dimensions in the multidimensional vector space corresponds to a number of patterns that the convolutional neural network machine learning model is trained to predict.

In some aspects, the techniques described herein relate to a method, wherein a partition position embedding value is added to a value of the multidimensional vector space.

In some aspects, the techniques described herein relate to a method, wherein the classification is a sign prediction.

In some aspects, the techniques described herein relate to a method, wherein the sign prediction is an upward indication.

In some aspects, the techniques described herein relate to a system including at least one computer including a processor and a memory, wherein the at least one computer is configured to: receive, at a forecasting platform, a time series; partition the time series into a plurality of partitions; process the time series with a convolutional neural network machine learning model; generate, by the convolutional neural network machine learning model, a plurality of tokens, wherein the plurality of tokens are based on the time series; process the plurality of tokens with a transformer machine learning model; generate, by the transformer machine learning model, a transformer vector, wherein the transformer vector is based on relationships among the plurality of tokens determined by the transformer machine learning model; and assign, by a multilayer perceptron classifier, a classification to the transformer vector.

In some aspects, the techniques described herein relate to a system, wherein each of the plurality of tokens corresponds to a partition of the plurality of partitions.

In some aspects, the techniques described herein relate to a system, wherein each of the plurality of tokens includes a multidimensional vector space.

In some aspects, the techniques described herein relate to a system, wherein a number of dimensions in the multidimensional vector space corresponds to a number of patterns that the convolutional neural network machine learning model is trained to predict.

In some aspects, the techniques described herein relate to a system, wherein a partition position embedding value is added to a corresponding vector space of the multidimensional vector space.

In some aspects, the techniques described herein relate to a system, wherein the classification is a sign prediction.

In some aspects, the techniques described herein relate to a system, wherein the sign prediction is an upward indication.

In some aspects, the techniques described herein relate to a non-transitory computer readable storage medium, including instructions stored thereon, which instructions, when read and executed by one or more computer processors, cause the one or more computer processors to perform steps including: receiving, at a forecasting platform, a time series; partitioning the time series into a plurality of partitions; processing the time series with a convolutional neural network machine learning model; generating, by the convolutional neural network machine learning model, a plurality of tokens, wherein the plurality of tokens are based on the time series; processing the plurality of tokens with a transformer machine learning model; generating, by the transformer machine learning model, a transformer vector, wherein the transformer vector is based on relationships among the plurality of tokens determined by the transformer machine learning model; and assigning, by a multilayer perceptron classifier, a classification to the transformer vector.

In some aspects, the techniques described herein relate to a non-transitory computer readable storage medium, wherein each of the plurality of tokens corresponds to a partition of the plurality of partitions.

In some aspects, the techniques described herein relate to a non-transitory computer readable storage medium, wherein each of the plurality of tokens includes a multidimensional vector space.

In some aspects, the techniques described herein relate to a non-transitory computer readable storage medium, wherein a number of dimensions in the multidimensional vector space corresponds to a number of patterns that the convolutional neural network machine learning model is trained to predict.

In some aspects, the techniques described herein relate to a non-transitory computer readable storage medium, wherein a partition position embedding value is added to a corresponding vector space of the multidimensional vector space.

In some aspects, the techniques described herein relate to a non-transitory computer readable storage medium, wherein the classification is a sign prediction.

### BRIEF DESCRIPTION OF THE DRAWINGS

FIG. 1 is a block diagram of a system for convolutional neural network and transformer-based time series modeling, in accordance with aspects.

FIG. 2 is a logical flow for convolutional neural network and transformer-based time series modeling, in accordance with aspects.

FIG. 3 is a block diagram of a computing device for implementing certain aspects of the present disclosure.

### DETAILED DESCRIPTION

Aspects generally relate to systems and methods for convolutional neural network and transformer-based time series modeling.

Aspects may leverage CNNs and transformers to model both short-term and long-term dependencies within a time series and assign a classification to resultant using a multilayer perceptron (MLP) head.

Forecasting based on certain times series has proven challenging where it involves statistically understanding complex linear and non-linear interactions within historical data to predict future events. For instance, in the financial industry, applications for forecasting include predicting buy/sell or positive/negative price changes for stocks and/or other securities traded on an open market. Due to both short-term and long-term temporal dependencies between data points on historical market data, however, such applications have not been particularly successful. In the computer vision domain, convolutional neural networks have shown success in learning local patterns which are suitable for modeling short-term dependencies, although not suitable for modeling long-term dependencies due to limited receptive field. Recently, machine learning (ML) models known as transformers (also referred to as vision transformers or transformer encoders) have shown much success in the natural language processing (NLP) domain, achieving very good performance on long-term dependencies modeling as compared to, e.g., long short-term memory (LSTM) models.

In accordance with aspects, a time series forecasting platform may use both CNNs and transformer models in order to predict a classification, such as a sign classification. A forecasting platform may include a convolutional neural network (CNN) engine which may include a software engine that is configured to execute on a server or other computer. A CNN engine may be configured to receive a time series as an input. A CNN engine may include one or more CNN machine learning models. An included CNN model may be trained to recognize a number of patterns for each partition in a time series. CNN models may be trained on relevant historical data and validated and tuned using a relevant validation data set. A CNN model may be configured to output a number of tokens, where the output tokens each include a multidimensional vector.

In accordance with aspects, a forecasting platform may format time series data as input to a CNN engine. Time series formatting may include partitioning of a time series into several smaller time widows. A partition window size of may be based on patterns that may emerge in a particular partition window (i.e., the window should not be too short to capture any patterns that may be in the time series), and/or an ability of computing resources to learn parameters within a window (i.e., the window should not be too large so as to introduce too many learning parameters with respect to compute resources). A time series may be expressed as a number of data points. For example, time series data points may reflect the fluctuation of a stock or other security price over a time period. That is, a forecasting platform input may be an end-of-day price of a stock for each day of an 90-day historical period. An alternative example may be based on an intra-day time period. For instance, time series data points may be a stock's price at 1-minute intervals for each minute of a 90-minute historical time period. A time series may be sampled at a time interval that will be predicted. That is, sampling will be made at according to the time period that will be predicted. Accordingly, for a predictive output for a subsequent minute, input time series values will be sampled at the minute level. A forecasting platform may take any necessary or desirable number of data points as input.

In accordance with aspects, a CNN model may act as a filter that passes over the input time series. A CNN model may be trained on historical data to determine relevant patterns (e.g., particular shapes) that are captured within each partition of the input time series. For instance, a CNN model may recognize particular patterns that are contained within one or more partitions of an input time series. Training of a CNN model, via machine learning, allows the model to recognize patterns are relevant in predicting an event with respect to the input data and how to compose a filter that identifies useful patterns and flags the patterns in the model's output. Such identification and flagging of relevant patterns is known as pattern activations.

In accordance with aspects, pattern activations may be output from a CNN model as tokens. Pattern activations may be vectorized and constructed as tokens. Aspects may include an output token for each partition of a times series. That is, for each partition of an input time series, a CNN model engine may output a corresponding token. Each output token may include pattern activations for each recognized pattern in a corresponding partition and may also include a position encoding that indicates the position of the token's corresponding time series partition with respect to the other partitions of the input time series. For instance, a token having an embedded position identifier of 1, first, 1st, etc., corresponds with the input time series partition having the same ordinal value and also includes pattern activations that the convolutional neural network identifies at that partition.

In accordance with aspects, output tokens may include a multi-dimensional vector space, so that multiple patterns may be represented in each token. In addition, a partition position encoding may be included in an output token, such that any patterns recognized in a token can be mapped or attributed to a correct time series partition from where the patterns were recognized. Recognizable patterns may be given an identifier, such as an ordinal identifier or key. For instance, if a CNN model has been trained to detect 10 discrete patterns in various partitions of an input time series, then the patterns may be labeled or identified as 1st, 2nd, 3rd, . . . 10th in an ordinal sequence of recognizable patterns. Moreover, an output token for a corresponding partition in a time series input may include a 10-dimensional vector space. Accordingly, if a CNN model then recognizes patterns with identifiers 1 and 2 in, e.g., a first partition of an input time series, the model may output a corresponding token having 1) a position embedding indicating that the token holds pattern activations for the first partition of the input time series, and 2) pattern activations in the first and second dimensions of the 10-dimension vector space. Such an exemplary output token would indicate that in the first partition of the subject time series, the CNN model recognized the pattern having the ordinal identifier 1 and the pattern having the ordinal identifier 2.

A partition position embedding (i.e., a partition position identifier) may be an additional vector space and may have the same dimensions (i.e., the same number of dimensions) as an output token. Partition position embeddings may be a set of separate parameters that are learned during an overall training process of the platform. For instance, if an output token is generated with a 10-dimensional vector space, a partition position embedding vector may also have a 10-dimensional vector space. In accordance with aspects, to embed a partition position embedding vector in an output token, values in each dimension of a partition position embedding vector may be added to values in each corresponding dimension of a vector space of an output token.

In some aspects, the number of dimensions of a vector may not reflect the actual number of recognizable patterns. For example, a 10-dimension vector may be encoded such that it represents and may indicate an index of more than ten pattern activations. Further, an N-dimensional position embedding may encode any number of positions (e.g., many more positions than N, theoretically up to an infinite number of positions. Accordingly, a 1-1 ratio of dimensions to values may not be required when designing and generating a token structure.

In accordance with aspects, token output from a CNN model may be used as input to a transformer machine learning (ML) model. A transformer model engine may include a software engine that is configured to execute on a server or other computer. A transformer model engine may be configured to receive multiple tokens generated by a CNN model engine as an input. A transformer model engine may include one or more transformer machine learning models. An included transformer ML model may be trained to recognize relationships between and/or correlations among a set of tokens and relevant impacts that determined relationships and correlations among the input tokens may have on the token set as a whole. A partition-identifying dimension of a vector space may be used by a transformer to identify a time series partition from which corresponding pattern activation data was collected.

In accordance with aspects, for a given sequence of input tokens, a transformer model may determine what tokens are closely related to each other and the weight of any impact a token has on other tokens in the context of all of the other input tokens in a set. A transformer model engine may facilitate training of a transformer model vie a relevant historical data set and may validate model output using a relevant validation data set. A transformer model engine may be configured to output a vector that includes the transformer model's determination with respect to the recognized relationships among an input token set. An output vector generated by a transformer model engine may essentially include a summary of the determinations made by a transformer model.

In accordance with aspects, a vector output from the transformer model (also referred to herein as a transformer vector) may be passed as input to a multilayer perceptron (MLP) head/classifier. An MLP classifier may take a transformer vector from a transformer model and determine a single classification from a collection of various classifications which to assign to the transformer vector. For instance, if input to a platform is a time series signal that represents a price fluctuation of a given stock or other financial security, an MLP classifier may determine and assign a classification from one of three available classifications: up, down, or flat. That is, an MLP classifier may classify input as a prediction that the price of a security will go up in a next increment of an analyzed time period, go down in the next increment of the analyzed time period, or stay flat in the next increment of the analyzed time period (i.e., remain unchanged or relatively unchanged).

MLP classifier output may be a probability distribution among available classes to which output may belong. The probabilities may all sum to 1 (e.g., a “go-up” probability may have a value of 0.70, a “go-down” probability may have a value of 0.25 and a “stay flat” probability may have a value of 0.05). The probability having the highest value may be considered the predicted classification. In some aspects, predictions may only be considered valid or accurate if/when a prediction is above a threshold probability. For instance, an output from a MLP classifier where no classification receives a score higher than, e.g., 0.65 may be considered unclassified.

In accordance with aspects, a forecasting platform's output may be a prediction for a time period that is of the same duration as the time period being analyzed and that is the immediate next time period outside of the analyzed series of time periods. For instance, where platform input is a daily value for a previous number of days, output is a prediction of the next day's value. Where input is a minute-by-minute value, the output is the next minute's predicted value. Accordingly, if input to a forecasting platform is a time series that includes 90 days of historical data, with the last day of historical data reflecting the current day's value, then the forecasting platform may output a prediction for tomorrow's value. In a security forecasting example, the forecasting platform may output a forecast of the sign for tomorrow's end-of-day price for the security based on the previous 90 days of historical price fluctuation.

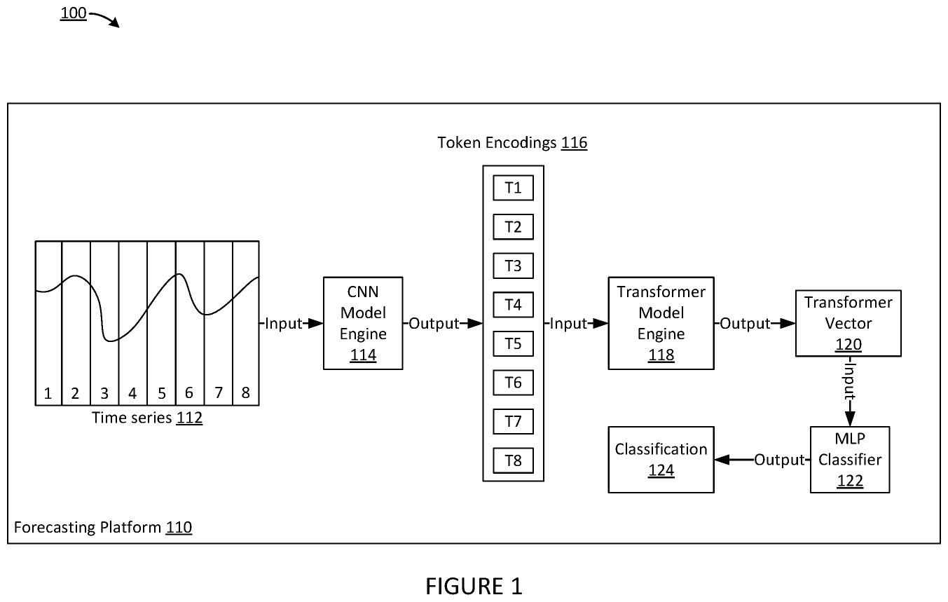

FIG. 1 is a block diagram of a system for convolutional neural network and transformer-based time series modeling, in accordance with aspects. System 100 includes forecasting platform 110. Forecasting platform 110 is shown with time series 112 as input to the platform. Forecasting platform 110 also includes CNN engine 114, transformer model engine 118, and MLP classifier 122 as components of forecasting platform 110. CNN engine 114, transformer model engine 118, and MLP classifier 122 may be configured as software modules (e.g., software programs or applications) that are configured to execute on hardware components such as computer servers. Token encodings 116 is depicted as output from CNN engine 114 and, along with learned corresponding position embeddings/encodings, may for input to transformer model engine 118. Transformer vector 120 is depicted as output from transformer model engine 118 and input to MLP classifier 122. Classification 124 is depicted as output from MLP classifier 122 and may be the final output of forecasting platform 110.

Time series 112 is partitioned into 8 partitions. Time series 112 may be any time series data. In an exemplary aspect, time series 112 may be historical security price data, such as the end-of-day price of a publicly traded stock over a time period such as the previous 90 days. Time series 112 is shown as input to convolutional neural network (CNN) engine 114. CNN engine 114 is a component of forecasting platform 110 and may include a CNN machine learning (ML) model. A model executed by CNN engine 114 may be trained using relevant historical data and model output may be validated using a validation data set. CNN engine 114 may receive time series 112 as input and may process time series 112 including exposing time series 112 to a CNN model of CNN engine 114. CNN engine 114 may output token encodings 116, which is an output group of tokens.

Token encodings 116 includes a token that corresponds to each partition in time series 112. For instance, token T1 of token encodings 116 may correspond to partition 1 of time series 112, token T2 may correspond to partition 2 of time series 112, and so on. Each token included in token encodings 116 may include a multidimensional vector space. The multidimensional vector space may include pattern activations recognized by CNN engine 114 in the partition of time series 112 that corresponds to the token. The multidimensional vector may include a sufficient number of dimensions to encode any patterns that are recognizable by time series 112 and to encode a position encoding (e.g., in one of the included dimensions) that represents the position of the corresponding partition of time series 112. Vector dimensions and pattern and position encodings are discussed in more detail, herein.

Each token in token encodings 116 may be passed as input to transformer model engine 118. Transformer model engine 118 may process the tokens of token encodings 116 to determine relationships between and/or correlations among the tokens and relevant impacts that determined relationships and correlations among the input tokens may have on the token set as a whole. Transformer model engine 118 may output transformer vector 120. Transformer vector 120 may include vector data that summarizes the relationships and correlations between the tokens or token encodings 116.

Transformer vector 120 may be passed as input to MLP classifier 122. MLP classifier 122 may be a classification machine learning model that is trained to assign one of a finite number of classifications to transformer vector 120. For instance, MLP classifier 122 may be trained to assign a sign classification when time series 112 includes price fluctuation data for a financial security. That is, MLP classifier 122 may be trained to assign one of three sign classes to transformer vector 120: a “move up” sign indicating that the price of the security will make a market move up in the next relevant time period (e.g., an upward indication), a “move down” sign indicating that the price of the security will make a market move up in the next relevant time period (e.g., a downward indication), or a “stay flat” sign indicating that the price of the security will remain constant or substantially close to constant in the next relevant time period (e.g., a level indication). This forecast or prediction may be output as classification 124.

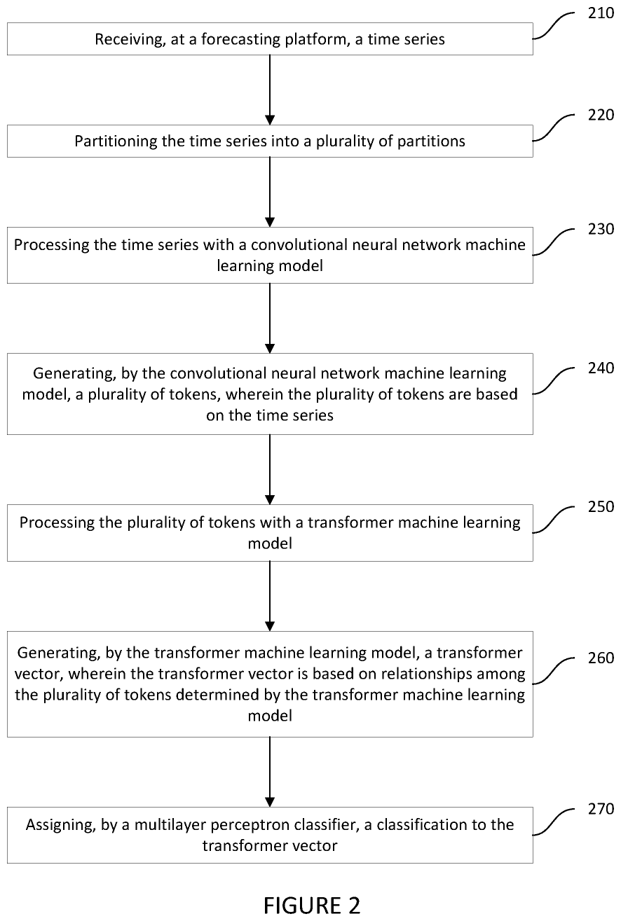

FIG. 2 is a logical flow for convolutional neural network and transformer-based time series modeling, in accordance with aspects.

Step 210 includes receiving, at a forecasting platform, a time series.

Step 220 includes partitioning the time series into a plurality of partitions.

Step 230 includes processing the time series with a convolutional neural network machine learning model.

Step 240 includes generating, by the convolutional neural network machine learning model, a plurality of tokens, wherein the plurality of tokens are based on the time series. In some aspects, each of the plurality of tokens corresponds to a partition of the plurality of partitions. In some aspects, each of the plurality of tokens includes a multidimensional vector space. In some aspects, a number of dimensions in the multidimensional vector space corresponds to a number of patterns that the convolutional neural network machine learning model is trained to predict. In some aspects, a partition position embedding vector is added to a value of the multidimensional vector space. For instance, a partition position embedding vector may be added to each token vector representing a pattern that a CNN extracts, and the sum of the vectors may be provided as input to a transformer machine learning model.

Step 250 includes processing the plurality of tokens with a transformer machine learning model.

Step 260 includes generating, by the transformer machine learning model, a transformer vector, wherein the transformer vector is based on relationships among the plurality of tokens determined by the transformer machine learning model.

Step 270 includes assigning, by a multilayer perceptron classifier, a classification to the transformer vector. In some aspects, the classification is a sign prediction. In some aspects, the sign prediction is an upward indication.

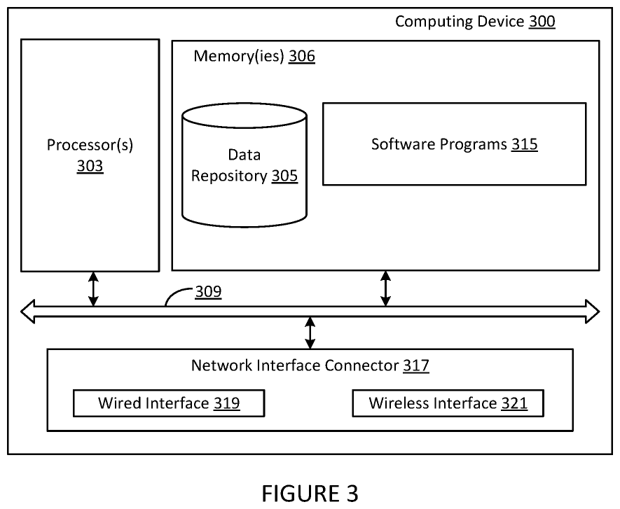

FIG. 3 is a block diagram of a computing device for implementing certain aspects of the present disclosure. FIG. 3 depicts exemplary computing device 300. Computing device 300 may represent hardware that executes the logic that drives the various system components described herein. For example, system components such as a CNN model engine, a transformer model engine, an MLP classifier, various database engines and database servers, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 300 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
receiving, at a forecasting platform, a time series;
partitioning the time series into a plurality of partitions;
processing the time series with a convolutional neural network machine learning model;
generating, by the convolutional neural network machine learning model, a plurality of tokens, wherein the plurality of tokens are based on the time series;
processing the plurality of tokens with a transformer machine learning model;
generating, by the transformer machine learning model, a transformer vector, wherein the transformer vector is based on relationships among the plurality of tokens determined by the transformer machine learning model; and
assigning, by a multilayer perceptron classifier, a classification to the transformer vector.

2. The method of claim 1, wherein each of the plurality of tokens corresponds to a partition of the plurality of partitions.

3. The method of claim 2, wherein each of the plurality of tokens includes a multidimensional vector space.

4. The method of claim 3, wherein a number of dimensions in the multidimensional vector space corresponds to a number of patterns that the convolutional neural network machine learning model is trained to predict.

5. The method of claim 4, wherein a partition position embedding value is added to a value of the multidimensional vector space.

6. The method of claim 1, wherein the classification is a sign prediction.

7. The method of claim 6, wherein the sign prediction is an upward indication.

8. A system comprising at least one computer including a processor and a memory, wherein the at least one computer is configured to:
receive, at a forecasting platform, a time series;
partition the time series into a plurality of partitions;
process the time series with a convolutional neural network machine learning model;
generate, by the convolutional neural network machine learning model, a plurality of tokens, wherein the plurality of tokens are based on the time series;
process the plurality of tokens with a transformer machine learning model;
generate, by the transformer machine learning model, a transformer vector, wherein the transformer vector is based on relationships among the plurality of tokens determined by the transformer machine learning model; and
assign, by a multilayer perceptron classifier, a classification to the transformer vector.

9. The system of claim 8, wherein each of the plurality of tokens corresponds to a partition of the plurality of partitions.

10. The system of claim 9, wherein each of the plurality of tokens includes a multidimensional vector space.

11. The system of claim 10, wherein a number of dimensions in the multidimensional vector space corresponds to a number of patterns that the convolutional neural network machine learning model is trained to predict.

12. The system of claim 11, wherein a partition position embedding value is added to a corresponding vector space of the multidimensional vector space.

13. The system of claim 8, wherein the classification is a sign prediction.

14. The system of claim 13, wherein the sign prediction is an upward indication.

15. A non-transitory computer readable storage medium, including instructions stored thereon, which instructions, when read and executed by one or more computer processors, cause the one or more computer processors to perform steps comprising:
receiving, at a forecasting platform, a time series;
partitioning the time series into a plurality of partitions;
processing the time series with a convolutional neural network machine learning model;
generating, by the convolutional neural network machine learning model, a plurality of tokens, wherein the plurality of tokens are based on the time series;
processing the plurality of tokens with a transformer machine learning model;
generating, by the transformer machine learning model, a transformer vector, wherein the transformer vector is based on relationships among the plurality of tokens determined by the transformer machine learning model; and
assigning, by a multilayer perceptron classifier, a classification to the transformer vector.

16. The non-transitory computer readable storage medium of claim 15, wherein each of the plurality of tokens corresponds to a partition of the plurality of partitions.

17. The non-transitory computer readable storage medium of claim 16, wherein each of the plurality of tokens includes a multidimensional vector space.

18. The non-transitory computer readable storage medium of claim 17, wherein a number of dimensions in the multidimensional vector space corresponds to a number of patterns that the convolutional neural network machine learning model is trained to predict.

19. The non-transitory computer readable storage medium of claim 18, wherein a partition position embedding value is added to a corresponding vector space of the multidimensional vector space.

20. The non-transitory computer readable storage medium of claim 15, wherein the classification is a sign prediction.
